(19) United States
(12) Patent Application Publication
(10) Pub. No.: US 2025/0383560 A1
(43) Pub. Date: Dec. 18, 2025

(54) DISPLAY DEVICE AND FILM

(71) Applicant: Japan Display Inc., Tokyo (JP)

(72) Inventors: Shinichiro OKA, Tokyo (JP); Yasushi TOMIOKA, Tokyo (JP)

(21) Appl. No.: 19/233,869

(22) Filed: Jun. 10, 2025

(30) Foreign Application Priority Data
Jun. 14, 2024 (JP) 2024-096656

(51) Int. Cl. G02F 1/1333; G02F 1/1335

(52) U.S. Cl. CPC G02F 1/133374; G02F 1/133528

(57) ABSTRACT

According to one embodiment, a display device includes a display panel having a display area displaying an image and a resin layer overlapping the display area. The resin layer has a first area, a second area having a refractive index different from that of the first area, and a third area having a refractive index different from those of the first area and the second area and adjacent to at least one of the first area and the second area.

### CROSS-REFERENCE TO RELATED APPLICATIONS

This application is based upon and claims the benefit of priority from Japanese Patent Application No. 2024-096656, filed Jun. 14, 2024, the entire contents of which are incorporated herein by reference.

### FIELD

Embodiments described herein relate generally to a display device and a film.

### BACKGROUND

Recently, various types of display devices have been proposed. For example, a display device in which patterns are printed in a display area in a transmissive ink to improve aesthetic of design is known. The reflectivity of a portion on which a pattern is formed is greater than those of portions on which no patterns are formed. Therefore, the pattern is emphasized when the display panel is in an off state. Thus, the pattern is visually recognizable in this state.

However, steps are formed due to presence or absence of the ink. When the display panel is in an on state, light is scattered on corner portions of the ink and thus the pattern becomes visually recognizable with overlapping a displayed image. Thus, the display quality may degrade.

### BRIEF DESCRIPTION OF THE DRAWINGS

FIG. 1 is a schematic plan view of a display device according to the first embodiment.

FIG. 2 is a schematic cross-sectional view of the display device according to the first embodiment.

FIG. 3 is a diagram showing a display device in which an illumination device and a display panel are in an off state or an on state.

FIG. 4 is a schematic diagram for explaining an example of a method of forming a first area, a second area, and a third area.

FIG. 5 is a schematic plan view showing an example of a mask.

FIG. 6 is a schematic cross-sectional view of a display device according to the second embodiment.

FIG. 7 is a schematic cross-sectional view of a display device according to the third embodiment.

FIG. 8 is a schematic plan view of a display device according to the fourth embodiment.

FIG. 9 is a schematic cross-sectional view of the display device according to the fourth embodiment.

FIG. 10 is a schematic cross-sectional view of a display device according to the fifth embodiment.

FIG. 11 is a schematic cross-sectional view of a display device according to the sixth embodiment.

FIG. 12 is a schematic cross-sectional view of a film according to the first embodiment.

FIG. 13 is a schematic plan view of the film according to the first embodiment.

FIG. 14 is a diagram showing a state where a film is bonded to a display device.

FIG. 15 is a schematic cross-sectional view of a film according to the second embodiment.

### DETAILED DESCRIPTION

In general, according to one embodiment, a display device includes a display panel having a display area displaying an image and a resin layer overlapping the display area. The resin layer has a first area, a second area having a refractive index different from that of the first area, and a third area having a refractive index different from those of the first area and the second area and adjacent to at least one of the first area and the second area.

In general, according to one embodiment, a film includes a base portion and a resin layer. The resin layer has a first area, a second area having a refractive index different from that of the first area, and a third area having a refractive index different from those of the first area and the second area and adjacent to at least one of the first area and the second area.

The embodiments can provide a display device and a film that can prevent the degradation in aesthetic of design.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plan view is defined as appearance when various types of elements are viewed parallel to the third direction Z.

### First Embodiment

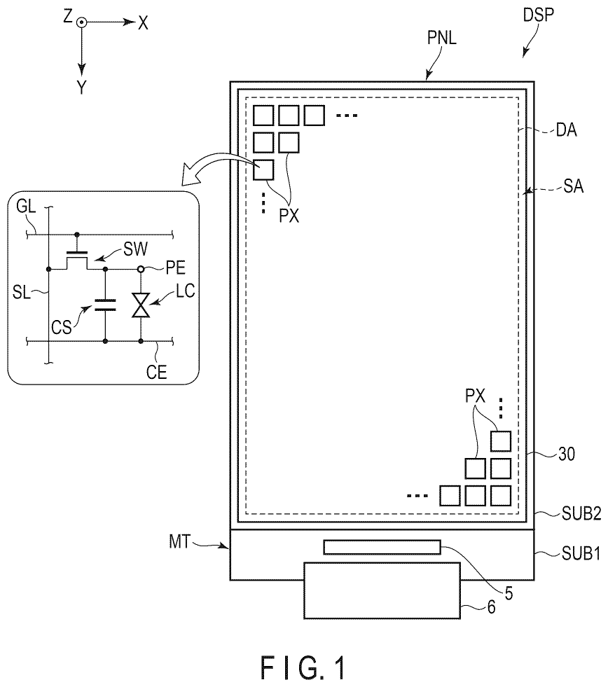

FIG. 1 is a schematic plan view of a display device DSP according to the first embodiment. The display device DSP according to the first embodiment is a liquid crystal display device. The display device DSP comprises a display panel PNL, an IC chip 5, a wiring board 6, and a resin layer 30. The display device DSP comprises an illumination device to be described later, the illumination device illuminating the display panel PNL.

The display panel PNL comprises a first substrate SUB1 and a second substrate SUB2. The first substrate SUB1 faces the second substrate SUB2 in the third direction Z. The first substrate SUB1 and the second substrate SUB2 are each formed into a flat plate shape parallel to the X-Y plane. In FIG. 1, each of the first substrate SUB1 and the second substrate SUB2 has a rectangular shape having long sides parallel to the second direction Y in plan view. The shapes of the first substrate SUB1 and the second substrate SUB2 are not limited to this example. For example, the shapes may be other shapes such as a rectangular shape having long sides parallel to the first direction X, a square shape, a circular shape, and an elliptical shape.

The display panel PNL has a display area DA and a surrounding area SA. The display area DA is an area for displaying an image. The display area DA comprises a plurality of pixels PX arrayed in a matrix in the first direction X and the second direction Y. The surrounding area SA surrounds the display area DA. The surrounding area SA includes a mounting portion MT. The mounting portion MT is a portion that does not overlap the second substrate SUB2 of the first substrate SUB1.

As shown in enlarged manner in FIG. 1, each of the plurality of pixels PX comprises a switching element SW, a pixel electrode PE, a common electrode CE, a liquid crystal layer LC, and the like. The switching element SW is constituted by, for example, a thin-film transistor (TFT) and is electrically connected to scanning lines GL and signal lines SL. The scanning line GL is electrically connected to the switching element SW in each of the pixels PX arranged in the first direction X. The signal line SL is electrically connected to the switching element SW in each of the pixels PX arranged in the second direction Y. The pixel electrode PE is electrically connected to the switching element SW. Each pixel electrode PE faces the common electrode CE, and drives the liquid crystal layer LC by an electric field produced between the pixel electrode PE and the common electrode CE. A capacitor CS is formed, for example, between an electrode having the same electric potential as the common electrode CE and an electrode having the same potential as the pixel electrode PE.

As an example, the scanning lines GL, the signal lines SL, the switching elements SW, the pixel electrode PE, and the common electrode CE are provided on the first substrate SUB1. The pixel electrode PE may be provided on the first substrate SUB1. The common electrode CE may be provided on the second substrate SUB2.

In the illustrated examples, the IC chip 5 and the wiring board 6 are mounted on the mounting portion MT. The IC chip 5 incorporates, for example, a display driver, which outputs a signal necessary for displaying images. The wiring board 6 is a flexible printed circuit, which can be bent. The IC chip 5 may be mounted on the wiring board 6.

The resin layer 30 overlaps the display area DA. In the illustrated examples, the edge of the resin layer 30 is located between the display area DA and an end portion of the second substrate SUB2. The resin layer 30 may cover the entire surface of the second substrate SUB2 or the display area DA alone. Details of the resin layer 30 will be described later.

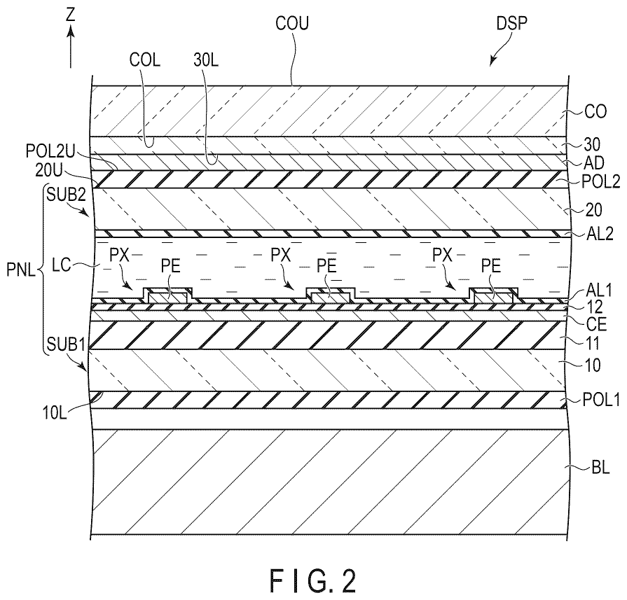

FIG. 2 is a schematic cross-sectional view of the display device DSP according to the first embodiment.

The display panel PNL comprises the first substrate SUB1, the second substrate SUB2, and the liquid crystal layer LC.

The first substrate SUB1 comprises a transparent substrate 10, insulating layers 11 and 12, the common electrode CE, the plurality of pixel electrodes PE, and a first alignment film AL1. The first substrate SUB1 is provided above an illumination device BL. The insulating layer 11 is provided on the transparent substrate 10. The common electrode CE is provided over a plurality of pixels PX on the insulating layer 11. The insulating layer 12 is provided on the common electrode CE. The plurality of pixel electrodes PE are provided for the respective pixels PX on the insulating layer 12. The first alignment film AL1 covers the plurality of pixel electrodes PE and the insulating layer 12. The common electrode CE may be provided above the plurality of pixel electrodes PE. The scanning lines GL, the signal lines SL, and the switching elements SW shown in FIG. 1 are provided between the transparent substrate 10 and the common electrode CE.

The second substrate SUB2 comprises a transparent substrate 20 and a second alignment film AL2. The second substrate SUB2 faces the first substrate SUB1 in the third direction Z. The second alignment film AL2 is provided below the transparent substrate 20. Though not illustrated, a light-shielding layer, a color filter layer, an overcoat layer, and the like may be further provided on the second substrate SUB2. The color filter layer may be provided on the first substrate SUB1.

The liquid crystal layer LC is provided between the first substrate SUB1 and the second substrate SUB2. In the example of FIG. 2, the liquid crystal layer LC is provided between the first alignment film AL1 and the second alignment film AL2.

The transparent substrates 10 and 20 are insulating substrates formed of glass, plastic, and the like.

The insulating layer 11 is formed of a transparent insulating material. For example, the insulating layer 11 includes an inorganic insulating layer and an organic insulating layer.

The insulating layer 12 is formed of, for example, a transparent inorganic insulating material such as a silicon nitride (SiNx).

The common electrode CE and the pixel electrode PE may be formed of, for example, a transparent conductive material such as an indium tin oxide (ITO) or an indium zinc oxide (IZO).

Each of the first alignment film AL1 and the second alignment film AL2 is a horizontal alignment film having an alignment restriction force along the X-Y plane. Each of the first alignment film AL1 and the second alignment film AL2 is an optical alignment film to which the alignment restriction force is imparted by ultraviolet irradiation. Each of the first alignment film AL1 and the second alignment film AL2 may be an alignment film subjected to rubbing treatment.

The display device DSP further comprises a first polarizer POL1, a second polarizer POL2, an adhesive layer AD, and a cover member CO.

The first polarizer POL1 is provided between the first substrate SUB1 and the illumination device BL. In the example of FIG. 2, the first polarizer POL1 is bonded to the lower surface of the first substrate SUB1. More specifically, the first polarizer POL1 is bonded to a lower surface 10L of the transparent substrate 10. The second polarizer POL2 is provided between the second substrate SUB2 and the resin layer 30. In the example of FIG. 2, the second polarizer POL2 is bonded to the upper surface of the second substrate SUB2. More specifically, the second polarizer POL2 is bonded to an upper surface 200 of the transparent substrate 20. Polarization axes of the first polarizer POLI and the second polarizer POL2 are orthogonal to each other on, for example, the X-Y plane.

The resin layer 30 is provided on a side opposite to the liquid crystal layer LC with the second substrate SUB2 interposed therebetween. The resin layer 30 is provided on a side opposite to the display panel PNL with the second polarizer POL2 interposed therebetween. The adhesive layer AD bonds the lower surface 30L of the resin layer 30 and an upper surface POL2U of the second polarizer POL2 together. For example, the adhesive layer AD is formed of a transparent material such as an optical clear adhesive (OCA) and an optical clearer resin (OCR). The refractive index of the adhesive layer AD is about 1.4 to 1.55.

The resin layer 30 is formed of a material whose refractive index varies according to ultraviolet irradiation. The resin layer 30 may be formed of a material whose refractive index increases by ultraviolet irradiation or a material whose refractive index decreases by ultraviolet irradiation.

As an example, the resin layer 30 is formed of an aromatic polyurethane. The aromatic polyurethane is synthesized by for example, polyaddition reaction of aromatic diisocyanate and a bifunctional alcohol. For example, as aromatic diisocyanates, for example, 4,4′-methylenediphenyl diisocyanate (MDI) and tolylene-2,4′-diisocyanate (TDI) can be used. For example, as a bifunctional alcohol, 1,4-bis(hydroxymethyl) benzene (HMB), 2-methyl-1,3-propanediol (MPDO), and 1,3-propanediol (PDO) can be used. Aromatic polyurethane is an example of a material whose refractive index increases by ultraviolet irradiation. The refractive index of aromatic polyurethane is about 1.58 to 1.65. This refractive index of the aromatic polyurethane includes both of the refractive index before the ultraviolet irradiation and the refractive index of after the ultraviolet irradiation.

The cover member CO is provided above the display panel PNL. The cover member CO has an inner surface COL (the first surface) facing the display panel PNL in the third direction Z and an outer surface COU (the second surface) on the side opposite to the inner surface COL. In the present embodiment, the resin layer 30 is provided on the inner surface COL.

The cover member CO is formed of a transparent material such as glass and plastic. As an example, the cover member CO is formed of alkali aluminum silicate glass. The cover member CO may be formed, for example, into a film shape. The cover member CO may have a function of shielding ultraviolet rays contained in external light. In that case, the cover member CO can suppress variation in the refractive index of the resin layer 30 due to ultraviolet rays contained in external light. The refractive index of the cover member CO is about 1.5.

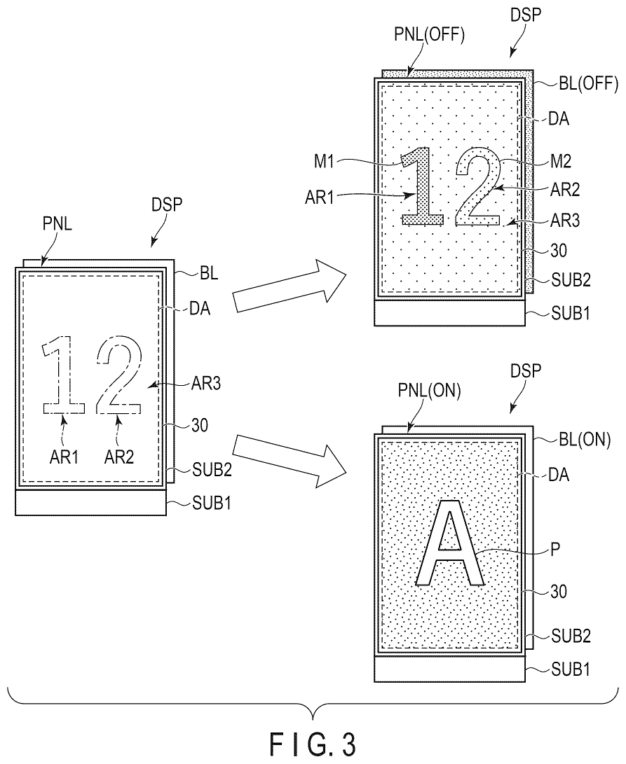

FIG. 3 is a diagram showing the display device DSP in which the illumination device BL and the display panel PNL are in the off state or in the on state. The left-side diagram in FIG. 3 shows a configuration of the display device DSP. The upper-right diagram in FIG. 3 shows the illumination device BL and the display panel PNL that are in the off state. The lower-right diagram in FIG. 3 shows the illumination device BL and the display panel PNL that are in the on state.

The off state of the illumination device BL corresponds to a state where all of light sources included in the illumination device BL are turned off. The on state of the illumination device BL corresponds to a state where at least one of the light sources included in the illumination device BL is turned on.

The off state of the display panel PNL corresponds to a state where no electric field is formed in the liquid crystal layer LC shown in FIG. 2 during the period where the illumination device BL is in the off state. Thus, no image is displayed in the display area DA during the period where the display panel PNL and the illumination device BL are in the off state.

The on state of the display panel PNL corresponds to a state where an electric field is formed in the liquid crystal layer LC during the period where the illumination device BL is in the on state. Therefore, an image can be displayed in the display area DA during the period where the display panel PNL and the illumination device BL are in the on state.

As shown in the left side of FIG. 3, the resin layer 30 is transparent and has a first area AR1, a second area AR2 having a refractive index different from that of the first area AR1, and a third area AR3 having a refractive index different from those of the first area AR1 and the second area AR2. The third area AR3 is adjacent to at least one of the first area AR1 and the second area AR2. In the example of FIG. 3, the first area AR1 and the second area AR2 are spaced apart from each other, and the third area AR3 is adjacent to the first area AR1 and the second area AR2. The third area AR3 surrounds the first area AR1 and the second area AR2. The first area AR1, the second area AR2, and the third area AR3 are formed of the same material.

The first area AR1, the second area AR2, and the third area AR3 have the same thickness. Thus, boundaries between the first area AR1, the second area AR2, and the third area AR3 have no steps. In other words, the resin layer 30 has a flat surface.

The first area AR1, the second area AR2, and the third area AR3 overlap the display area DA. For example, the first area AR1 and the second area AR2 are areas for displaying letters and figures. In the example of FIG. 3, each of the first area AR1 and the second area AR2 has a size in plan view smaller than that of the third area AR3. The first area AR1 has the refractive index higher than that of the second area AR2. The second area AR2 has the refractive index higher than that of the third area AR3.

The magnitude relationship between the refractive indices of the first area AR1, the second area AR2, and the third area AR3 is not limited to this example. Further, the resin layer 30 may include more than four areas having different refractive indices.

The refractive indices of the first area AR1, the second area AR2, and the third area AR3 are different from the refractive indices of the cover member CO and the adhesive layer AD shown in FIG. 2. For example, the refractive indices of the first area AR1, the second area AR2, and the third area AR3 are smaller than that of the cover member CO and are greater than that of the adhesive layer AD.

As shown in the upper-right of FIG. 3, during the period where the illumination device BL and the display panel PNL are in the off state, when the external light is made incident on the display device DSP, the external light is refracted in the first area AR1, the second area AR2, and the third area AR3. The first area AR1, the second area AR2, and the third area AR3 have different refractive indices. Light refracted on the first area AR1, the second area AR2, and the third area AR3 travels in different directions. Light passing through the first area AR1, the second area AR2, and the third area AR3 each has different travel directions. Thus, a user can visually recognize the first area AR1 as a pattern M1 and the second area AR2 as a pattern M2. Refractive index differences between the first area AR1, the second area AR2, and the third area AR3 must be 0.003 or more to make the patterns M1 and M2 visually recognizable. The patterns M1 and M2 are formed according to the refractive index differences between the first area AR1, the second area AR2, and the third area AR3. Thus, greater refractive index differences are preferable in terms of improving visibility of the patterns M1 and M2.

As shown in the lower-right of FIG. 3, during the period where the illumination device BL and the display panel PNL are in the on state, the display panel PNL is illuminated with the light from the illumination device BL and thus an image P is displayed in the display area DA. The resin layer 30 is transparent. Thus, display light forming the image P passes through the resin layer 30. This allows a user to visually recognize the image P. At this time, if the refractive index differences between the first area AR1, the second area AR2, and the third area AR3 are great, display light is refracted in different directions in the respective first area AR1, the second area AR2, and the third area AR3. This may make the image P visually recognizable with overlapping the patterns M1 and M2. Therefore, the refractive index differences between the first area AR1, the second area AR2, and the third area AR3 are preferably less than or equal to 0.1 in terms of suppressing the decrease in the visibility of the image P.

Next, a method of forming the first area AR1, the second area AR2, and the third area AR3 will be described.

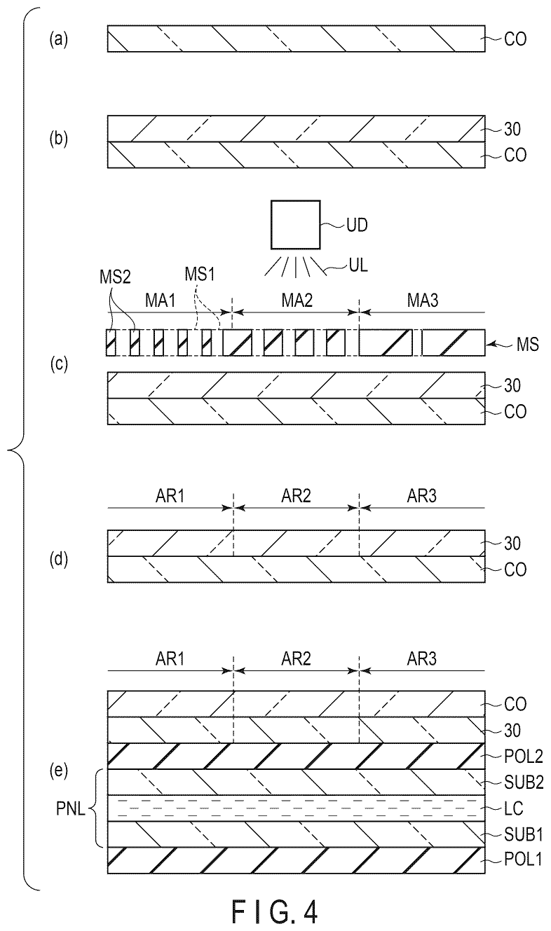

FIG. 4 is a schematic diagram for explaining an example of the method of forming the first area AR1, the second area AR2, and the third area AR3.

First, as shown in FIG. 4 (a), the cover member CO is prepared.

Next, as show in FIG. 4 (b), the resin layer 30 is formed by applying a material for forming the resin layer 30 to the cover member CO and then drying it. For example, an ink-jet method or a spin coating method is used as the method of the material application method. For example, aromatic polyurethane is used as the material.

Next, as shown in FIG. 4 (c), a mask MS is provided above the resin layer 30. A gray scale may be used as the mask MS. As an example, the mask MS may include a translucent portion MS1 allowing the ultraviolet ray UL to pass through it and a light-shielding portion MS2 shielding the ultraviolet ray UL. Further, the mask MS has a first mask area MA1, a second mask area MA2, and a third mask area MA3 respectively corresponding to the first area AR1, the second area AR2, and the third area AR3 shown in FIG. 3. The ratio of the translucent portion MS1 within the area is the highest in the first mask area MA1, followed by the second mask area MA2 and the third mask area MA3. The ratio of the light-shielding portion MS2 within the area is the highest in the third mask area MA3, followed by the second mask area MA2 and the first mask area MA1.

Thereafter, an ultraviolet irradiation device UD irradiates the resin layer 30 with the ultraviolet ray UL through the translucent portion MS1 of the mask MS. The mask MS has the highest translucent amount for the ultraviolet ray UL in the first mask area MA1, followed by the second mask area MA2 and the third mask area MA3. When the resin layer 30 is formed of a material whose refractive index increases according to the irradiation of the ultraviolet ray UL, the area irradiated with the ultraviolet ray UL has a high refractive index, compared to before being irradiated with the ultraviolet ray UL. In contrast, the refractive indices of the areas that are not irradiated with the ultraviolet ray UL do not substantially vary between before and after the irradiation of the ultraviolet ray UL. For example, in a case where aromatic polyurethane is used, the refractive index of the first area AR1 irradiated with the ultraviolet ray UL increases by about 0.04 after the ultraviolet irradiation, and the refractive index of the second area AR2 irradiated with the ultraviolet ray UL increases by about 0.02 after the ultraviolet irradiation. In the third area AR3, the resin layer 30 is hardly irradiated with the ultraviolet ray UL due to the mask MS, the refractive index of the third area AR3 hardly changes between before and after the irradiation of the ultraviolet ray UL.

As shown in FIG. 4 (d), this forms the first area AR1 (a high refractive index area) and the second area AR2 (a middle refractive index area), which are irradiated with the ultraviolet ray UL and the third area AR3 (a low refractive index area), which is hardly irradiated with the ultraviolet ray UL.

Next, as shown in FIG. 4 (e), the first polarizer POL1 and the second polarizer POL2 are bonded to the display panel PNL in which the first substrate SUB1, the liquid crystal layer LC, and the second substrate SUB2 are stacked in this order (from the bottom to the top). Then the cover member CO in which the resin layer 30 is formed, is bonded to the second polarizer POL2 by means of adhesive.

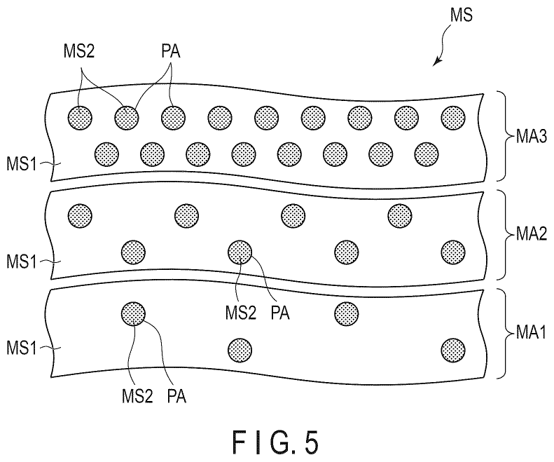

FIG. 5 is a schematic plan view showing an example of the mask MS. In the example shown in FIG. 5, a circular pattern PA shielding ultraviolet rays is formed on the mask MS. The pattern PA is formed of, for example, a material shielding ultraviolet rays and is formed by a method such as the ink-jet method. The size in plan view of the pattern PA corresponds to that of the light-shielding portion MS2.

In the example shown in FIG. 5, the pattern PA is formed on each of the first mask area MA1, the second mask area MA2, and the third mask area MA3. The ratio of the pattern PA within the area is the highest in the third mask area MA3, followed by the second mask area MA2 and the first mask area MA1. The first mask area MA1 may be formed of the translucent portion MS1 alone. The third mask area MA3 may be formed of the light-shielding portion MS2 alone. The mask MS is not limited to the example shown in FIG. 5. For example, the mask MS may be a halftone-type phase shifting mask. Using such masks MS can adjust translucent amount for ultraviolet ray.

According to the present embodiment, the resin layer 30 overlapping the display area DA has the first area AR1, the second area AR2, and the third area AR3 that have different refractive indices. These refractive index differences make the patterns M1 and M2 visually recognizable. This can increase the aesthetic of design.

In addition, the resin layer 30 is covered with the cover member CO. The cover member CO can prevent the surface of the resin layer 30 from wearing and the like. Thus, this suppresses a degradation in the aesthetic of design due to deficits in the resin layer 30.

The first area AR1, the second area AR2, and the third area AR3 have the same thickness. Thus, this configuration involves no step at the boundaries between the first area AR1, the second area AR2, and the third area AR3, suppressing undesirable scattering of light. In particular, this configuration can suppress scattering of external light in a state where the illumination device BL and the display panel PNL are in the on state, and scattering of the display light. Therefore, this configuration can suppress degradation in display quality of an image displayed in the display area DA.

In the present embodiment, the resin layer 30 contacts the cover member CO and the adhesive layer AD. In this embodiment, the patterns M1 and M2 of the resin layer 30 is visually recognizable when at least one of a refractive index difference between the resin layer 30 and the cover member CO and a refractive index difference between the resin layer 30 and the adhesive layer AD is a prescribed refractive index difference.

For example, when the refractive index difference between the resin layer 30 and the cover member CO is the prescribed refractive index difference, light is refracted on the interface between the resin layer 30 and the cover member CO and thus the patterns M1 and M2 become visually recognizable. The refractive index of the resin layer 30 (the refractive index of each of the first area AR1, the second area AR2, and the third area AR3) may be greater than or smaller than the refractive index of the cover member co.

For example, when the refractive index difference between the resin layer 30 and the adhesive layer AD is the prescribed refractive index difference, light is refracted on the interface between the resin layer 30 and the adhesive layer AD and thus the patterns M1 and M2 become visually recognizable. The refractive index of the resin layer 30 may be greater or smaller than the refractive index of the adhesive layer AD.

Even when both of the refractive index differences between the resin layer 30 and the cover member CO and the refractive index difference between the resin layer 30 and the adhesive layer AD are the prescribed refractive index difference, the resin layer 30 has an extremely thin thickness of about 1 μm. This thickness does not cause multiple reflections accounting for degradation in the visibility.

### Second Embodiment

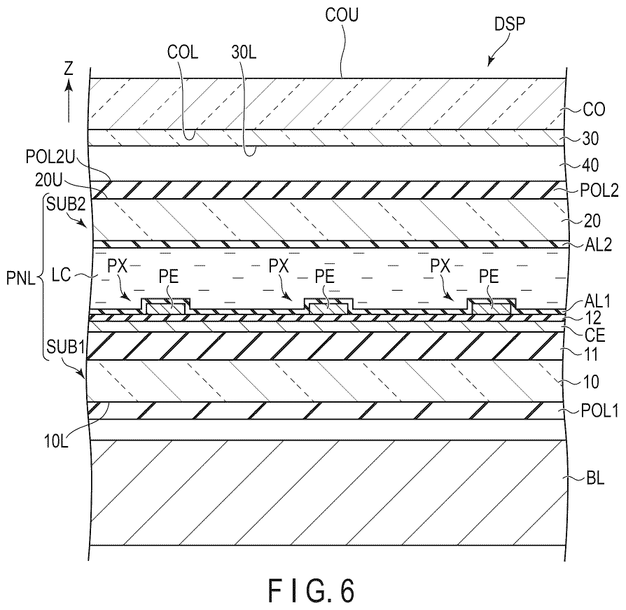

Next, the second embodiment will be described. FIG. 6 is a schematic cross-sectional view of a display device DSP according to the second embodiment. The same elements as those of the first embodiment are denoted by the same reference numbers. Overlapping descriptions of these elements are omitted.

In the display device DSP shown in FIG. 6, an air layer 40 is interposed between a resin layer 30 and a second polarizer POL2. The refractive index of the resin layer 30 is greater than the refractive index of the air layer 40. Thus, light is refracted on the interface (a lower surface 30L) between the resin layer 30 and the air layer 40. Thus, the patterns M1 and M2 are visually recognizable in the display device DSP shown in FIG. 6 as well. In addition, the resin layer 30 is covered with a cover member CO. This configuration suppresses a degradation in the aesthetic of design due to the deficit in the resin layer 30.

In addition to this effect, the display device DSP of the second embodiment exhibits the same effects as those exhibited by the display device DSP of the first embodiment.

### Third Embodiment

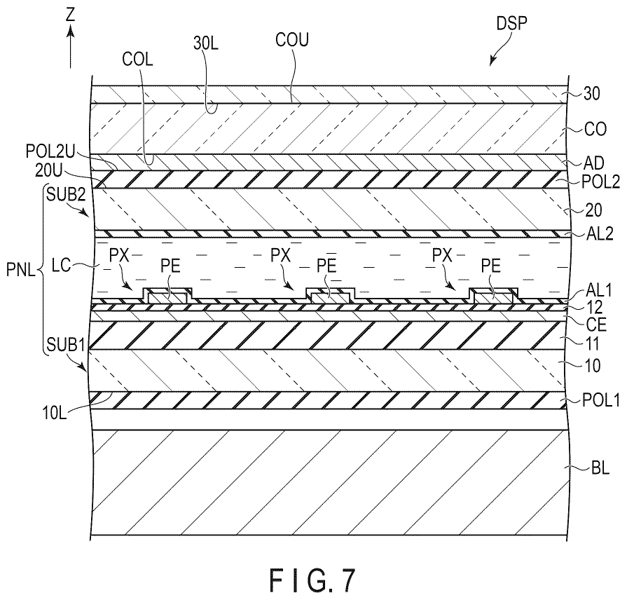

Next, the third embodiment will be described. FIG. 7 is a schematic cross-sectional view of a display device DSP according to the third embodiment. The same elements as those of the embodiments are denoted by the same reference numbers. Overlapping descriptions of these elements are omitted.

In the display device DSP shown in FIG. 7, a resin layer 30 is provided on an outer surface COU of a cover member CO. An inner surface COL of the cover member CO and an upper surface POL2U of a second polarizer POL2 are bonded together by an adhesive layer AD. In the example shown in FIG. 7, the upper surface of the resin layer 30 contacts the air outside. This configuration allows light to be refracted on the interface between the resin layer 30 and air, making patterns M1 and M2 visually recognizable. The resin layer 30 contacts the cover member CO. Thus, when a refractive index difference between the resin layer 30 and the cover member CO is a prescribed refractive index difference, the patterns M1 and M2 of the resin layer 30 become visually recognizable. Thus, the third embodiment can achieve the same effects as those of the embodiments described above as well.

The display device DSP may further comprise an ultraviolet ray shielding layer, which is provided on the resin layer 30 and has a function of shielding ultraviolet rays contained in external light. In the example shown in FIG. 7, the resin layer 30 is provided on the outer surface COU of the cover member CO. The resin layer 30 may be provided on the upper surface POL2U of the second polarizer POL2.

### Fourth Embodiment

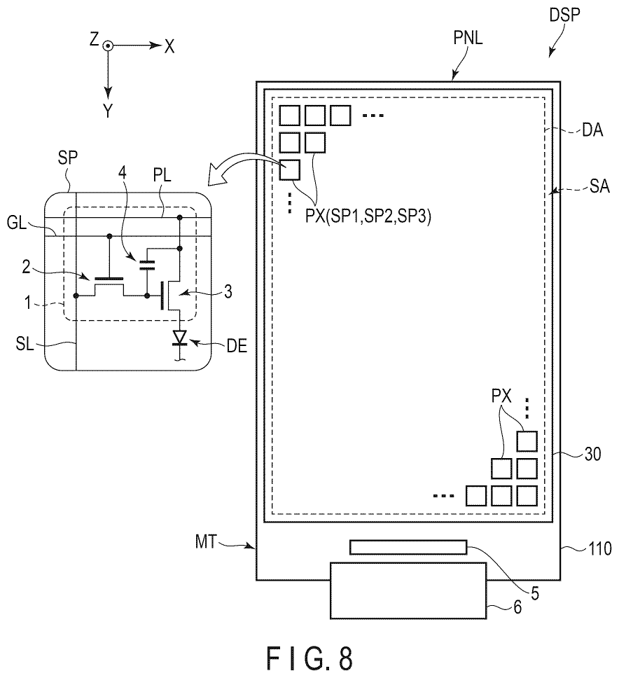

Next, the fourth embodiment will be described. FIG. 8 is a schematic plan view of a display device DSP according to the fourth embodiment. The same elements as those of the embodiments are denoted by the same reference numbers. Overlapping descriptions of these elements are omitted.

The display device DSP of the fourth embodiment is an organic electroluminescent display device comprising, for example, an organic light emitting diode (OLED) as display elements. The display device DSP comprises a display panel PNL. The display panel PNL comprises an insulating substrate 110. In FIG. 8, the insulating substrate 110 has a rectangular shape having long sides parallel to the second direction Y in plan view. The shape of the insulating substrate 110 is not limited to this example. For example, the shape may be other shape such as a rectangular shape having long sides parallel to the first direction X, a square shape, a circular shape, and an elliptical shape. The insulating substrate 110 is formed of, for example, an insulating material such as glass or plastic.

The display area DA comprises a plurality of pixels PX arrayed in a matrix in the first direction X and the second direction Y. Each pixel PX comprises a plurality of subpixels SP. As an example, the pixel PX includes a red subpixel SP1, a green subpixel SP2, and a blue subpixel SP3. In addition to the subpixels of the above three colors, the pixel PX may comprise four or more subpixels including a subpixel of another color such as white.

As shown in enlarged manner in FIG. 8, the subpixel SP comprises a pixel circuit 1 and a display element DE driven by the pixel circuit 1. The pixel circuit 1 comprises a pixel switch 2, a drive transistor 3, and a capacitor 4. The pixel switch 2 and the drive transistor 3 are, for example, switching elements constituted by thin-film transistors.

In the pixel switch 2, a gate electrode is connected to scanning lines GL. Either a source electrode or a drain electrode of the pixel switch 2 is connected to a signal line SL. The other is connected to a gate electrode of the drive transistor 3 and the capacitor 4. In the drive transistor 3, one of the source electrode and the drain electrode is connected to a power line PL and the capacitor 4. The other is connected to the anode of the display element DE. The configuration of the pixel circuit 1 is not limited to the illustrated example.

The display element DE is an organic light emitting diode (OLED) as a light emitting element. For example, the subpixel SP1 comprises a display element DE that emits light corresponding to a red wavelength, the subpixel SP2 comprises a display element DE that emits light corresponding to a green wavelength, and the subpixel SP3 comprises a display element DE that emits light corresponding to a blue wavelength. The display element DE is not limited to the organic light emitting diode and may be other light emitting elements such as micro light emitting diodes.

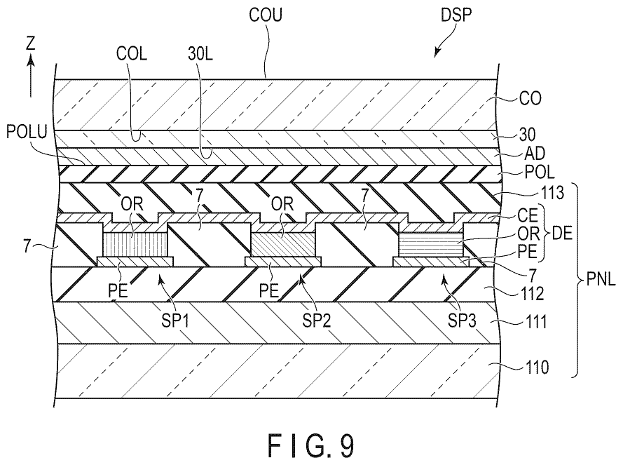

FIG. 9 is a schematic cross-sectional view of the display device DSP according to the fourth embodiment.

The display panel PNL comprises the insulating substrate 110, a circuit layer 111, insulating layers 112 and 113, a rib 7, and a plurality of display elements DE provided above the insulating substrate 110. The circuit layer 111 is provided on the insulating substrate 110. The circuit layer 111 is covered with the insulating layer 112.

The circuit layer 111 includes various circuits such as the pixel circuit 1 shown in FIG. 8 and various lines such as the scanning lines GL, the signal lines SL, and the power lines PL. As an example, the insulating layer 112 includes an inorganic insulating layer and an organic insulating layer.

The display element DE includes a pixel electrode PE, an organic layer OR, and a common electrode CE. The pixel electrode PE is provided in each subpixel SP. The common electrode CE is provided to be shared with the plurality of display elements DE. The organic layer OR is provided between the pixel electrode PE and the common electrode CE.

The pixel electrode PE is provided on the insulating layer 112. The rib 7 is provided on the insulating layer 112 and the pixel electrode PE. A peripheral portion of the pixel electrode PE is covered with the rib 7. The organic layer OR is provided on the pixel electrode PE. The organic layer OR is surrounded by the rib 7. The common electrode CE covers the organic layer OR and the rib 7.

The organic layer OR includes a light emitting layer composed of an organic EL material. The organic layer OR may include functional layers such as a hole injection layer, a hole transport layer, an electron blocking layer, a hole blocking layer, an electron transport layer, and an electron injection layer.

The insulating layer 113 covers the plurality of display elements DE. In FIG. 9, the insulating layer 113 covers the common electrode CE. The insulating layer 113 includes an organic layer, which planarizes the uneven parts formed by the rib 7 and an inorganic layer (a sealing layer) protecting the organic layer OR from moisture and the like.

The display device DSP further comprises a polarizer POL provided above the insulating layer 113, an adhesive layer AD, and a cover member CO.

The polarizer POL is bonded to the upper surface of the insulating layer 113. The resin layer 30 faces the polarizer POL in the third direction Z. That is, the resin layer 30 is provided on a side opposite to the display panel PNL with the polarizer POL interposed therebetween. The resin layer 30 is provided on an inner surface COL of the cover member CO. The adhesive layer AD bonds a lower surface 30L of the resin layer 30 and an upper surface POLU of the polarizer POL together.

Thus, the patterns M1 and M2 are visually recognizable in the display device DSP shown in FIG. 9 as well. In addition, the resin layer 30 is covered with the cover member CO. This configuration suppresses a degradation in the aesthetic of design due to the deficit in the resin layer 30.

In addition to this effect, the display device DSP of the fourth embodiment exhibits the same effects as those exhibited by the display devices DSP of each of the embodiments.

### Fifth Embodiment

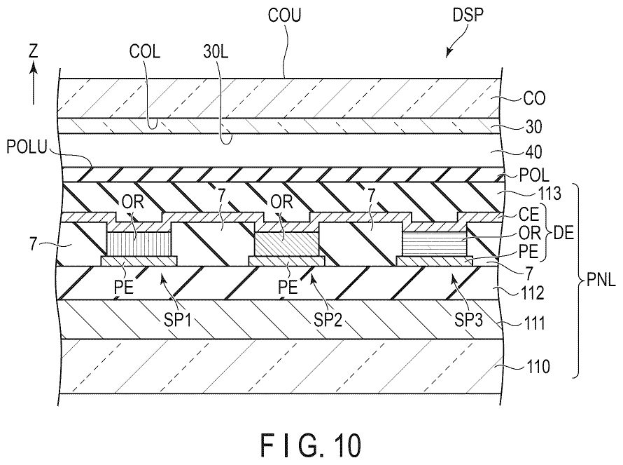

Next, the fifth embodiment will be described. FIG. 10 is a schematic cross-sectional view of the display device DSP according to the fifth embodiment. The same elements as those of the embodiments are denoted by the same reference numbers. Overlapping descriptions of these elements are omitted.

In the display device DSP shown in FIG. 10, an air layer 40 is interposed between a resin layer 30 and a polarizer POL. The patterns M1 and M2 are visually recognizable in the present embodiment as well.

In addition, the resin layer 30 is covered with a cover member CO. This configuration suppresses a degradation in the aesthetic of design due to the deficit in the resin layer 30.

In addition to this effect, the display device DSP of the fifth embodiment exhibits the same effects as those exhibited by the display devices DSP of each of the embodiments.

### Sixth Embodiment

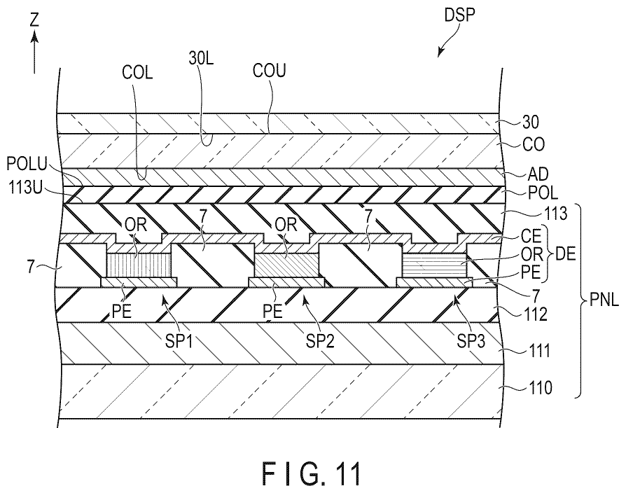

Next, the sixth embodiment will be described. FIG. 11 is a schematic cross-sectional view of a display device DSP according to the sixth embodiment. The same elements as those of the embodiments are denoted by the same reference numbers. Overlapping descriptions of these elements are omitted.

In the display device DSP shown in FIG. 11, a resin layer 30 is provided on an outer surface COU of a cover member CO. An inner surface COL of the cover member CO and an upper surface POLU of a polarizer POL are bonded together by an adhesive layer AD. In the example shown in FIG. 11, the upper surface of the resin layer 30 contacts the air outside. This configuration allows light to be refracted on the interface between the resin layer 30 and air, making patterns M1 and M2 visually recognizable. The resin layer 30 contacts the cover member CO. Thus, when a refractive index difference between the resin layer 30 and the cover member CO is a prescribed refractive index difference, the patterns M1 and M2 of the resin layer 30 become visually recognizable. Thus, the sixth embodiment can achieve the same effects as those of the embodiments described above as well.

The display device DSP may further comprise an ultraviolet ray shielding layer, which is provided on the resin layer 30 and has a function of shielding ultraviolet rays contained in external light. In the example shown in FIG. 11, the resin layer 30 is provided on the outer surface COU of the cover member CO. The resin layer 30 may be provided on the upper surface POLU of the polarizer POL.

Next, a film using the resin layer 30 will be described. The same elements as those of the embodiments are denoted by the same reference numbers. Overlapping descriptions of these elements are omitted.

### First Embodiment

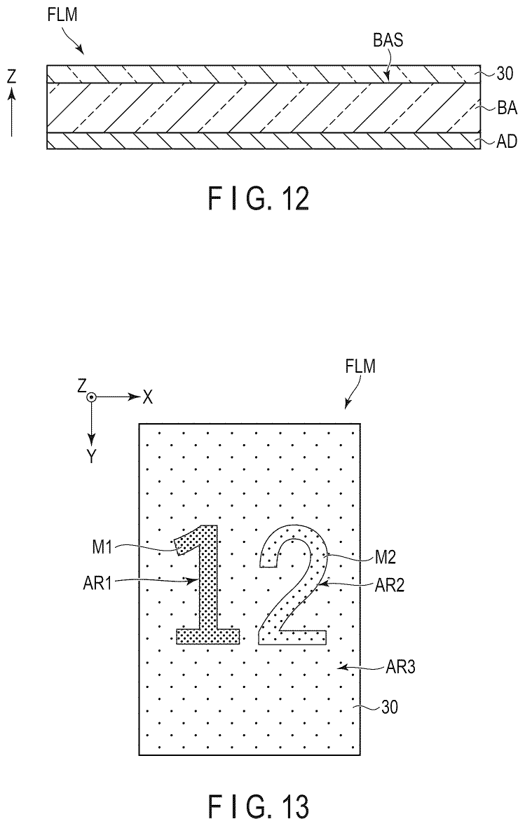

FIG. 12 is a schematic cross-sectional view of a film FLM according to the first embodiment. The film FLM comprises a base material BA, a resin layer 30, and an adhesive layer AD.

The base material BA has a surface BAS and formed into a thin sheet shape. For example, the base material BA is formed of a resin material such as a polyethylene terephthalate (PET), a polyimide (PI), and a polyethylene naphthalate (PEN) and a transparent material such as glass. For example, the refractive index of the base material BA is about 1.5 degrees.

As described above, the resin layer 30 is formed of a material whose refractive index varies according to ultraviolet irradiation. As an example, the resin layer 30 is formed of an aromatic polyurethane. The resin layer 30 is provided on the surface BAS of the base material BA. The resin layer 30 may cover the entire surface BAS or part of it.

As described above, the adhesive layer AD is formed of transparent materials. In the example shown in FIG. 12, the adhesive layer AD is provided on the side opposite to the resin layer 30 with the base material BA interposed therebetween.

FIG. 13 is a schematic plan view of the film FLM according to the first embodiment. As described above, the resin layer 30 has the first area AR1, the second area AR2 having a refractive index different from that of the first area AR1, and the third area AR3 having a refractive index different from those of the first area AR1 and the second area AR2 and adjacent to at least one of the first area AR1 and the second area AR2.

The first area AR1, the second area AR2, and the third area AR3 have different refractive indices. Thus, light passing through the first area AR1, the second area AR2, and the third area AR3 respectively has different travel directions. This allows a user to visually recognize the first area AR1 as the pattern M1 and the second area AR2 as the pattern M2. Refractive index differences between the first area AR1, the second area AR2, and the third area AR3 must be 0.003 or more to make the patterns M1 and M2 visually recognizable.

The film FLM according to the present embodiment can make the patterns M1 and M2 visually recognizable according to the refractive index differences between the first area AR1, the second area AR2, and the third area AR3. This can increase the aesthetic of design.

In the present embodiment, the adhesive layer AD is provided on the side opposite to the resin layer 30 with the base material BA interposed therebetween. That is, the resin layer 30 does not contact the adhesive layer AD. This configuration can prevent alteration and degradation of the resin layer 30 resulting from the adhesive layer AD and thus increase the number of choices for materials forming the resin layer 30.

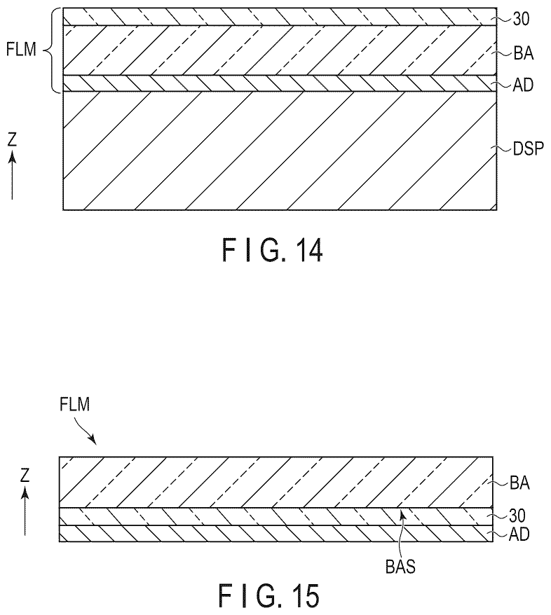

FIG. 14 is a diagram showing a state where the film FLM is bonded to the display device DSP. The display device DSP shown in FIG. 14 may be the display device DSP of the above embodiments or common display devices available on the market. The adhesive layer AD bonds the film FLM to the surface of the display device DSP. The bonding method of the film FLM is not limited to the method using the adhesive layer AD. For example, the film FLM may be bonded to the display device DSP by static electricity. In that case, the film FLM may not comprise the adhesive layer AD.

Bonding the film FLM to the display device DSP in this manner can increase the aesthetic of design of the display device DSP. The film FLM can be bonded to not only the display device DSP but also various items.

### Second Embodiment

FIG. 15 is a schematic cross-sectional view of a film FLM according to the second embodiment. In the example shown in FIG. 15, an adhesive layer AD is provided on the side opposite to a base material BA with a resin layer 30 interposed therebetween. This film FLM protects the resin layer 30 using the base material BA, preventing damage to the resin layer 30 and suppressing aging degradation of the film FLM.

All of the display devices and the films that can be implemented by a person of ordinary skill in the art through arbitrary design changes to the display devices and the films described above as the embodiment of the present invention come within the scope of the present invention as long as they are in keeping with the spirit of the present invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or by adding or omitting a step or changing the condition of a step, all of the modifications fall within the scope of the present invention as long as they are in keeping with the spirit of the invention.

Further, other effects which may be obtained from the above embodiments and are self-explanatory from the descriptions of the specification or can be arbitrarily conceived by a person of ordinary skill in the art are considered as the effects of the present invention as a matter of course.

What is claimed is:

1. A display device, comprising:
a display panel having a display area displaying an image;
a resin layer overlapping the display area, wherein
the resin layer has a first area, a second area having a refractive index different from that of the first area, and a third area having a refractive index different from those of the first area and the second area and adjacent to at least one of the first area and the second area.

2. The display device of claim 1, wherein
refractive index differences between the first area, the second area, and the third area are 0.003 or more.

3. The display device of claim 1, wherein
the resin layer is formed of an aromatic polyurethane.

4. The display device of claim 1, wherein
the resin layer is formed of a material whose refractive index varies according to ultraviolet irradiation.

5. The display device of claim 1, further comprising:
a cover member having a first surface facing the display panel and a second surface located on a side opposite to the first surface, wherein
the resin layer is provided on the first surface or the second surface of the cover member.

6. The display device of claim 5, wherein
the first area, the second area, and the third area have refractive indices different from that of the cover member.

7. The display device of claim 5, further comprising:
an illumination device illuminating the display panel;
a first polarizer; and
a second polarizer, wherein
the display panel comprises a first substrate, a second substrate facing the first substrate, and a liquid crystal layer provided between the first substrate and the second substrate,
the first polarizer is provided between the first substrate and the illumination device,
the second polarizer is provided between the second substrate and the resin layer, and
the resin layer is provided on a side opposite to the display panel with the second polarizer interposed therebetween.

8. The display device of claim 7, wherein
the resin layer is provided on the first surface, and
the display device further comprises an adhesive layer bonding the resin layer and the second polarizer together.

9. The display device of claim 7, wherein
the resin layer is provided on the first surface, and
an air layer is interposed between the resin layer and the second polarizer.

10. The display device of claim 5, wherein
the display panel comprises an insulating substrate, a plurality of display elements facing the insulating substrate, and an insulating layer covering the plurality of display elements,
the display device further comprises a polarizer facing the insulating layer, and
the resin layer is provided on a side opposite to the display panel with the polarizer interposed therebetween.

11. The display device of claim 10, wherein
the resin layer is provided on the first surface, and
the display device further comprises an adhesive layer bonding the resin layer and the polarizer together.

12. The display device of claim 10, wherein
the resin layer is provided on the first surface, and
an air layer is interposed between the resin layer and the polarizer.

13. The display device of claim 10, wherein
each of the plurality of display elements is a light emitting diode.

14. The display device of claim 8, wherein
the first area, the second area, and the third area have refractive indices different from that of the adhesive layer.

15. A film comprising:
a base; and
a resin layer having a first area, a second area having a refractive index different from that of the first area, and a third area having a refractive index different from those of the first area and the second area and adjacent to at least one of the first area and the second area, the resin layer being provided on the base material.

16. The film of claim 15, wherein
refractive index differences between the first area, the second area, and the third area are 0.003 or more.

17. The film of claim 15, wherein
the resin layer is formed of an aromatic polyurethane.

18. The film of claim 15, wherein
the resin layer is formed of a material whose refractive index varies according to ultraviolet irradiation.

19. The film of claim 15, further comprising:
an adhesive layer provided on a side opposite to the resin layer with the base material interposed therebetween.

20. The film of claim 15, further comprising:
an adhesive layer provided on a side opposite to the base material with the resin layer interposed therebetween.
